(19) United States
(12) Patent Application Publication
(10) Pub. No.: US 2013/0088939 A1
(43) Pub. Date: Apr. 11, 2013

(54) WAVEFIELD SEPARATION USING A GRADIENT SENSOR

(71) Applicants: Pascal Edme, Cambridge (GB); Everhard Johan Muyzert, Girton (GB); Johan O. A. Robertsson, Grantchester (GB)

(72) Inventors: Pascal Edme, Cambridge (GB); Everhard Johan Muyzert, Girton (GB); Johan O. A. Robertsson, Grantchester (GB)

(21) Appl. No.: 13/269,908

(22) Filed: Oct. 10, 2011

(51) Int. Cl. G01V 1/28

(52) U.S. Cl. 367/43

(57) ABSTRACT

Seismic data relating to a subterranean structure is received from at least one translational survey sensor, and gradient sensor data is received from at least one gradient sensor. A P wavefield and an S wavefield in the seismic data are separated, based on combining the seismic data and the gradient sensor data.

### BACKGROUND

Seismic surveying is used for identifying subterranean elements, such as hydrocarbon reservoirs, freshwater aquifers, gas injection zones, and so forth. In seismic surveying, seismic sources are placed at various locations on a land surface or seafloor, with the seismic sources activated to generate seismic waves directed into a subterranean structure.

The seismic waves generated by a seismic source travel into the subterranean structure, with a portion of the seismic waves reflected back to the surface for receipt by seismic sensors (e.g. geophones, accelerometers, etc.). These seismic sensors produce signals that represent detected seismic waves. Signals from the seismic sensors are processed to yield information about the content and characteristic of the subterranean structure.

A typical land-based seismic survey arrangement includes deploying an array of seismic sensors on the ground. Marine surveying typically involves deploying seismic sensors on a streamer or seabed cable.

### SUMMARY

In general, according to some embodiments, seismic data relating to a subterranean structure is received from at least one translational survey sensor. Gradient sensor data is received from at least one gradient sensor. A P wavefield and an S wavefield in the seismic data are separated, based on the seismic data and the gradient sensor data.

In general, according to further embodiments, a system includes a storage medium to store seismic data acquired by at least one translational survey sensor, and gradient sensor data acquired by at least one gradient sensor. The system further includes at least one processor to combine the seismic data and the gradient sensor data to derive a P wavefield and an S wavefield.

In general, according to other embodiments, an article includes at least one machine-readable storage medium storing instructions that upon execution cause a system to receive seismic data relating to a subterranean structure from at least one translational survey sensor, receive gradient sensor data from at least one gradient sensor, and separate a P wavefield and an S wavefield in the seismic data, based on combining the seismic data and the gradient sensor data.

Other or alternative features will become apparent from the following description, from the drawings, and from the claims.

### BRIEF DESCRIPTION OF THE DRAWINGS

Some embodiments are described with respect to the following figures:

FIG. 1 is a schematic diagram of an example arrangement of sensor assemblies that can be deployed to perform seismic surveying, according to some embodiments;

FIGS. 2 and 3 are schematic diagrams of sensor assemblies according to various embodiments; and

FIGS. 4 and 5 are flow diagrams of processes of wavefield separation according to various embodiments.

### DETAILED DESCRIPTION

In seismic surveying (marine or land-based seismic surveying) of a subterranean structure, seismic sensors are used to measure seismic data, such as displacement, velocity or acceleration data. Seismic sensors can include geophones, accelerometers, MEMS (microelectromechanical systems) sensors, or any other types of sensors that measure the translational motion (e.g. displacement, velocity, and/or acceleration) of the surface at least in the vertical direction and possibly in one or both horizontal directions. Such sensors are referred to as translational survey sensors, since they measure translational (or vectorial) motion.

Each seismic sensor can be a single-component (1C), two-component (2C), or three-component (3C) sensor. A 1C sensor has a sensing element to sense a wavefield along a single direction; a 2C sensor has two sensing elements to sense wavefields along two directions (which can be generally orthogonal to each other, to within design, manufacturing, and/or placement tolerances); and a 3C sensor has three sensing elements to sense wavefields along three directions (which can be generally orthogonal to each other).

A seismic sensor at the earth's surface can record the vectorial part of an elastic wavefield just below the free surface (land surface or seafloor, for example). When multicomponent sensors are deployed, the vector wavefields can be measured in multiple directions, such as three orthogonal directions (vertical Z, horizontal inline X, horizontal crossline Y). In marine seismic survey operations, hydrophone sensors can additionally be provided with the multicomponent vectorial sensors to measure pressure fluctuations in water.

Recorded seismic data can contain contributions from noise, including horizontal propagation noise such as ground-roll noise. Ground-roll noise refers to seismic waves produced by seismic sources, or other sources such as moving cars, engines, pump and natural phenomena such as wind and ocean waves, that travel generally horizontally along an earth surface towards seismic receivers. These horizontally travelling seismic waves, such as Rayleigh waves or Love waves, are undesirable components that can contaminate seismic data. Another type of ground-roll noise includes Scholte waves that propagate horizontally below a seafloor. Other types of horizontal noise include flexural waves or extensional waves. Yet another type of noise includes an air wave, which is a horizontal wave that propagates at the air-water interface in a marine survey context.

Ground-roll noise is typically visible within a shot record (collected by one or more seismic sensors) as a high-amplitude, typically elliptically polarized, low-frequency, low-velocity, dispersive noise train. Ground-roll noise often distorts or masks reflection events containing information from deeper subsurface reflectors. To enhance accuracy in determining characteristics of a subterranean structure based on seismic data collected in a seismic survey operation, it is desirable to eliminate or attenuate contributions from noise, including ground-roll noise or another type of noise.

After ground-roll noise removal, it is often assumed that the vertical component of the measured seismic data contains mainly P waves while the horizontal component(s) of the seismic data contains mainly S waves. A P wave (or P wavefield) is a compression wave, while an S wave (or S wavefield) is a shear wave. The P wavefield extends in the direction of propagation of a seismic wave, while the S wavefield extends in a direction generally perpendicular to the direction of propagation of the seismic wave.

The foregoing assumption that the vertical component of the measured seismic data contains mainly P waves while the horizontal component(s) contain(s) mainly S waves is valid for nearly vertically impinging wavefields, but may not be valid for impinging wavefields having larger incident angles (such as due to large offsets or distances between survey sources and survey sensors). At larger offsets between survey sources and survey sensors, each component of measured seismic data (vertical component or horizontal component) contains a mixture of P and S wavefields, making data processing more difficult and interpretation more challenging.

Moreover, survey sensors are usually placed just below the free surface (land surface or seafloor, for example), from which up-coming wave energy is reflected and converted into downgoing energy. In other words, a seismic sensor placed just below the free surface measures both upgoing wavefields and downgoing wavefields (that are reflected from the upgoing wavefields). Thus, it may also be desirable to separate the different components of the wavefield (upgoing P wavefield, upgoing S wavefield, downgoing P wavefield, and downgoing S wavefield) to analyze different events in the wavefields reflected from a subterranean element, such as a reservoir at depth.

The ability to decompose seismic data into the separate components (upgoing and downgoing P wavefields, and upgoing and downgoing S wavefields) would usually allow a crisper image of the subterranean structure to be produced. Such a crisper image of the subterranean structure can be useful for various analyses, such as AVO (amplitude variations with offset) analysis, inversion techniques, and so forth. In addition, joint analysis of separated P and S wavefields can provide useful information regarding subsurface lithology and structures.

In accordance with some embodiments, to decompose measured seismic data (measured by at least one translational survey sensor) into P and S wavefields, gradient sensor data from at least one gradient sensor can be used. A gradient sensor refers to a sensor that measures one or more spatial derivatives of seismic wavefield, such as a sensor that measures curl and/or a sensor that measures a divergence of the wavefield. A sensor that measures the curl of a wavefield can be a rotational sensor, while a sensor that measures divergence of the wavefield can be a divergence sensor.

In other implementations, other types of gradient sensors can be used. For example, instead of measuring rotation data by a rotational sensor, rotation data can be derived from translational seismic data measured by closely-spaced translational survey sensors (which are separated by less than some predefined distance or offset).

Rotation data refers to the rotational component of the seismic wavefield. As an example, one type of rotational sensor to measure rotation data is the R-1 rotational sensor from Eentec, located in St. Louis, Mo. In other examples, other rotational sensors can be used.

Rotation data refers to a rate of a rotation (or change in rotation over time) about an axis, such as about the horizontal inline axis (X) and/or about the horizontal crossline axis (Y) and/or about the vertical axis (Z). In the marine seismic surveying context, the inline axis X refers to the axis that is generally parallel to the direction of motion of a streamer of survey sensors. The crossline axis Y is generally orthogonal to the inline axis X The vertical axis Z is generally orthogonal to both X and E In the land-based seismic surveying context, the inline axis X can be selected to be any horizontal direction, while the crossline axis Y can be any axis that is generally orthogonal to X.

In some examples, a rotational sensor can be a multi-component rotational sensor that is able to provide measurements of rotation rates around multiple orthogonal axes (e.g. R_{X} about the inline axis X, R_{Y} about the crossline axis Y, and R_{Z} about the vertical axis Z). Generally, Rᵢ represents rotation data, where the subscript i represents the axis (X, Y, or Z) about which the rotation data is measured.

In alternative implementations, instead of using a rotational sensor to measure rotation data, the rotation data can be derived from measurements (referred to as “vectorial data” or “translational data”) of at least two closely-spaced apart seismic sensors used for measuring a seismic wavefield component along a particular direction, such as the vertical direction Z. Rotation data can be derived from the vectorial data of closely-based seismic sensors that are within some predefined distance of each other (discussed further below).

In some examples, the rotation data can be obtained in two orthogonal components. A first component is in the direction towards the source (rotation around the crossline axis, Y, in the inline-vertical plane, X-Z plane), and the second component is perpendicular to the first component (rotation around the inline axis, X in the crossline-vertical plane, Y-Z plane).

As sources may be located at any distance and azimuth from the rotational sensor location, the first component may not always be pointing towards the source while the second component may not be perpendicular to the first component. In these situations, the following pre-processing may be applied that mathematically rotates both components towards the geometry described above. Such a process is referred to as vector rotation, which provides data different from measured rotation data to which the vector rotation is applied. The measured rotation components R_{X} and R_{Y} are multiplied with a matrix that is function of an angle θ between the X axis of the rotational sensor, and the direction of the source as seen from the rotational sensor.

$$[ \begin{matrix}{R}_{I} \\ {R}_{C}\end{matrix} ] = [ \begin{matrix}cos θ & - sin θ \\ sin θ & cos θ\end{matrix} ] \cdot [ \begin{matrix}{R}_{y} \\ {R}_{x}\end{matrix} ] .$$

The foregoing operation results in the desired rotation in the Y-Z plane (R_{C}) and X-Z plane (R_{I}).

Another optional pre-processing step is the time (t) integration of the rotation data. This step can be mathematically described as:

R′ₓ=∫ₜ₌₀^{t=end}Rₓ dt.

The foregoing time integration of the rotation data results in a phase shift in the waveform and shift of its spectrum towards lower frequencies.

In some implementations, a divergence sensor used to measure divergence data is formed using a container filled with a material in which a pressure sensor (e.g. a hydrophone) is provided. The material in which the pressure sensor is immersed can be a liquid, a gel, or a solid such as sand or plastic. The pressure sensor in such an arrangement is able to record a seismic divergence response of a subsurface.

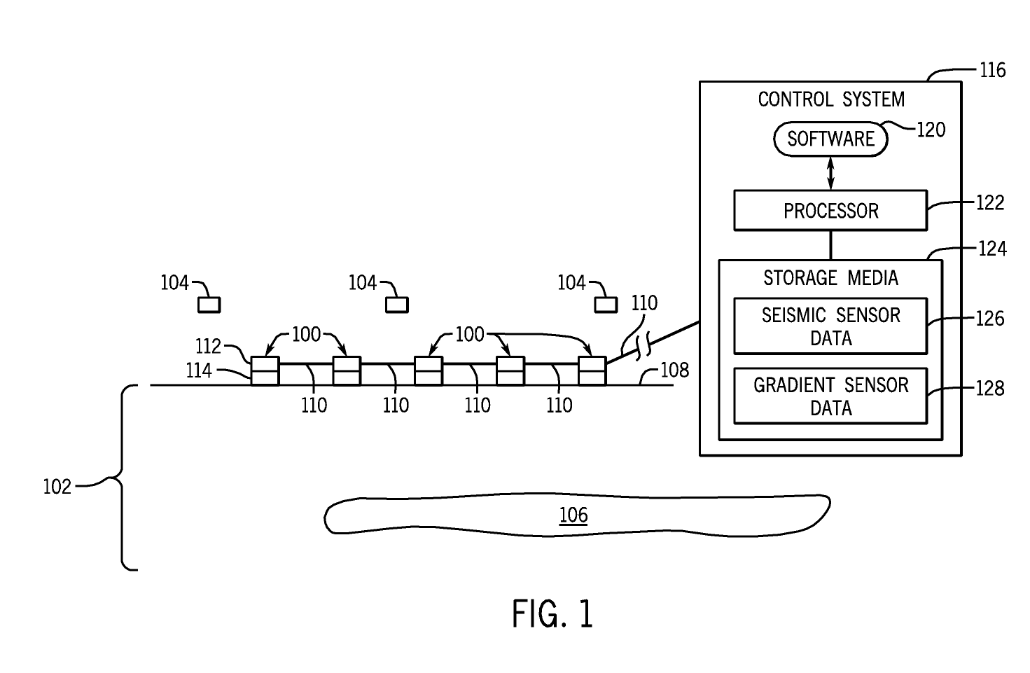

FIG. 1 is a schematic diagram of an arrangement of sensor assemblies (sensor stations) 100 that are used for land-based seismic surveying. Note that techniques or mechanisms can also be applied in marine surveying arrangements. The sensor assemblies 100 are deployed on a ground surface 108 (in a row or in an array). A sensor assembly 100 being “on” a ground surface means that the sensor assembly 100 is either provided on and over the ground surface, or buried (fully or partially) underneath the ground surface such that the sensor assembly 100 is with 10 meters of the ground surface. The ground surface 108 is above a subterranean structure 102 that contains at least one subterranean element 106 of interest (e.g. hydrocarbon reservoir, freshwater aquifer, gas injection zone, etc.). One or more seismic sources 104, which can be vibrators, air guns, explosive devices, and so forth, are deployed in a survey field in which the sensor assemblies 100 are located. The one or more seismic sources 104 are also provided on the ground surface 108.

Activation of the seismic sources 104 causes seismic waves to be propagated into the subterranean structure 102. Alternatively, instead of using controlled seismic sources as noted above to provide controlled source or active surveys, techniques according to some implementations can be used in the context of passive surveys. Passive surveys use the sensor assemblies 100 to perform one or more of the following: (micro)earthquake monitoring; hydro-frac monitoring where microearthquakes are observed due to rock failure caused by fluids that are actively injected into the subsurface (such as to perform subterranean fracturing); and so forth.

Seismic waves reflected from the subterranean structure 102 (and from the subterranean element 106 of interest) are propagated upwardly towards the sensor assemblies 100. Seismic sensors 112 (e.g. geophones, accelerometers, etc.) in the corresponding sensor assemblies 100 measure the seismic waves reflected from the subterranean structure 102. Moreover, in accordance with various embodiments, the sensor assemblies 100 further include gradient sensors 114 that are designed to measure gradient sensor data (e.g. rotation data and/or divergence data).

Although a sensor assembly 100 is depicted as including both a seismic sensor 112 and a gradient sensor 114, note that in alternative implementations, the seismic sensors 112 and gradient sensors 114 can be included in separate sensor assemblies. In either case, however, a seismic sensor and a corresponding associated gradient sensor are considered to be collocated—multiple sensors are “collocated” if they are each located generally in the same location, or they are located near each other to within some predefined distance, e.g., less than 5 meters, of each other.

In some implementations, the sensor assemblies 100 are interconnected by an electrical cable 110 to a control system 116. Alternatively, instead of connecting the sensor assemblies 100 by the electrical cable 110, the sensor assemblies 100 can communicate wirelessly with the control system 116. In some examples, intermediate routers or concentrators may be provided at intermediate points of the network of sensor assemblies 100 to enable communication between the sensor assemblies 100 and the control system 116.

The control system 116 shown in FIG. 1 further includes processing software 120 that is executable on one or more processors 122. The processor(s) 122 is (are) connected to storage media 124 (e.g. one or more disk-based storage devices and/or one or more memory devices). In the example of FIG. 1, the storage media 124 is used to store seismic data 126 communicated from the seismic sensors 112 of the sensor assemblies 100 to the control system 116, and to store gradient sensor data 128 communicated from the gradient sensors 114.

In operation, the processing software 120 is used to process the seismic data 126 and the gradient sensor data 128. The gradient sensor data 128 is combined with the seismic data 126, using techniques discussed further below, to separate P and S wavefields in the seismic data 126. The processing software 120 can then process the separated P and S wavefields to produce an output.

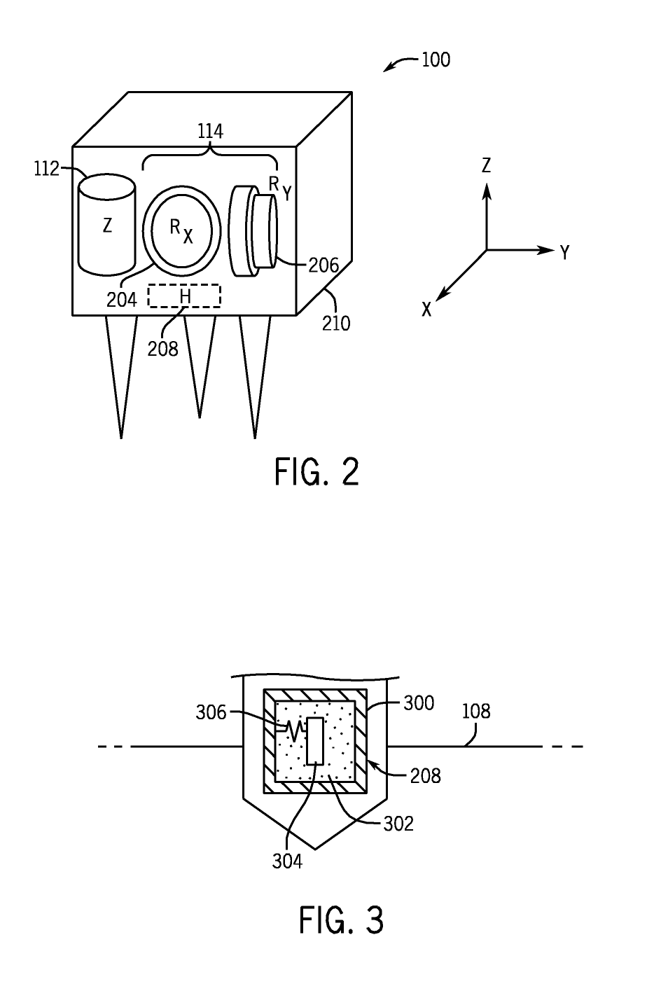

FIG. 2 illustrates an example sensor assembly (or sensor station) 100, according to some examples. The sensor assembly 100 can include a seismic sensor 112, which can be a particle motion sensor (e.g. geophone or accelerometer) to sense particle velocity along a particular axis, such as the Z axis. In alternative examples, the sensor assembly 100 can additionally or alternatively include particle motion sensors to sense particle velocity along a horizontal axis, such as the X or Y axis. In addition, the sensor assembly 100 includes a first rotational sensor 204 that is oriented to measure a crossline rate of rotation (R_{X}) about the inline axis (X axis), and a second rotational sensor 206 that is oriented to measure an inline rate of rotation (R_{Y}) about the crossline axis (Y axis). In other examples, the sensor assembly 100 can include just one of the rotational sensors 204 and 206. In further alternative examples where rotation data is derived from Z seismic data measured by closely-spaced apart seismic sensors, as discussed above, both the sensors 204 and 206 can be omitted. The sensor assembly 100 has a housing 210 that contains the sensors 112, 204, and 206.

The sensor assembly 100 further includes (in dashed profile) a divergence sensor 208, which can be included in some examples of the sensor assembly 100, but can be omitted in other examples.

An example of a divergence sensor 208 is shown in FIG. 3. The divergence sensor 208 has a closed container 300 that is sealed. The container 300 contains a volume of liquid 302 (or other material such as a gel or a solid such as sand or plastic) inside the container 300. Moreover, the container 300 contains a hydrophone 304 (or other type of pressure sensor) that is immersed in the liquid 302 (or other material). The hydrophone 304 is mechanically decoupled from the walls of the container 300. As a result, the hydrophone 304 is sensitive to just acoustic waves that are induced into the liquid 302 through the walls of the container 300. To maintain a fixed position, the hydrophone 304 is attached by a coupling mechanism 306 that dampens propagation of acoustic waves through the coupling mechanism 306. Examples of the liquid 302 include the following: kerosene, mineral oil, vegetable oil, silicone oil, and water. In other examples, other types of liquids or another material can be used.

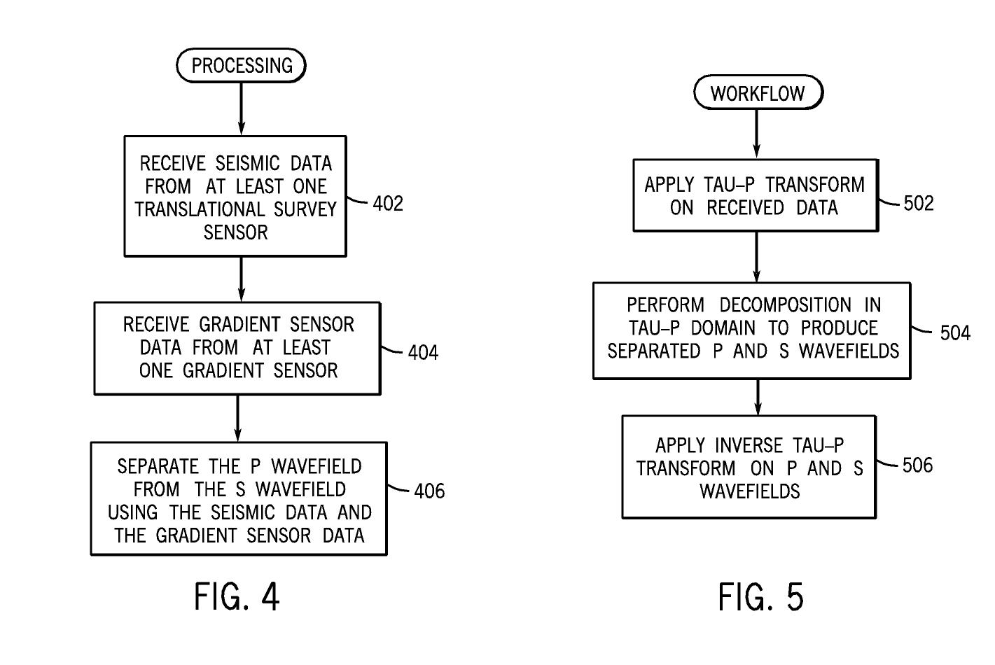

FIG. 4 is a flow diagram of a process according to some embodiments. The process can be performed by the processing software 120 in the control system 116, for example. Alternatively, the process can be performed by another control system. The process receives (at 402) seismic data (translational data) relating to a subterranean structure, where the seismic data is acquired by at least one translational survey sensor (e.g. 112 in FIG. 1). The process also receives (at 404) gradient sensor data from at least one gradient sensor (e.g. 114 in FIG. 1).

The process then separates (at 406) a P wavefield and an S wavefield in the seismic data, based on the seismic data and the gradient sensor data. In some implementations, the separation (406) can produce an upgoing P wavefield, a downgoing P wavefield, an upgoing S wavefield, and a downgoing S wavefield.

The following describes further details relating to use of gradient sensor data for performing decomposition of seismic data into P and S wavefields. In practice, the recorded divergence data (U_{H}), as recorded by a divergence sensor, at or just under the free surface, is proportional to the sum of the spatial derivatives of the inline and crossline horizontal translational data (as recorded by a translational survey sensor such as a geophone, accelerometer, or MEMS sensor, for example):

$$\frac{\partial {U}_{H}}{\partial t} = {K}_{D} {K}_{S} ( \frac{\partial {U}_{X}}{\partial x} + \frac{\partial {U}_{Y}}{\partial y} ) , \qquad ( Eq . 1 )$$

where U_{X} and U_{Y} are the inline and crossline translational fields (in the X and Y directions, respectively). The K_{D}K_{S} term is a calibration operator that depends on the seismic sensor assembly characteristics, the coupling with the ground and the elastic properties of the ground in the vicinity of the seismic sensor assembly. In accordance with some embodiments, the calibration term that is computed is K_{D}K_{S}. The parameter K_{S} depends on a characteristic of the near-surface subterranean medium. The parameter K_{D} converts pressure fluctuations outside the divergence sensor into pressure fluctuations inside the divergence sensor. Thus, K_{D} is related to a characteristic of the sensor assembly that includes the divergence sensor. In implementations where the divergence sensor has a container in which a pressure sensing element is positioned, the parameter K_{D} converts pressure fluctuations outside the container into pressure fluctuations inside the container. In practice, the parameter K_{D} may also include terms to compensate for the fact that the divergence sensor and the seismic sensors have different impulse responses and different coupling with the ground. For example, K_{D}=K_{cal} K_{coup}, where K_{cal} compensates for the fact that the divergence and seismic sensors have different impulse responses (among others, different electric amplification, etc.) and K _{coup} compensates for the fact that the divergence and seismic sensors have different coupling with the ground. Further details regarding calculating K_{D}K_{S} is described in U.S. Ser. No. 12/939,331, entitled “Computing A Calibration Term Based On Combining Divergence Data And Seismic Data,” filed Nov. 4, 2010, which is hereby incorporated by reference.

The inline rotational data R_{X} (around the inline axis X), as measured by a rotational sensor, is proportional to the crossline spatial derivative of the vertical translational field (U_{Z}), as measured by a translational survey sensor having a sensing element oriented in the Z direction:

$$\frac{\partial {R}_{X}}{\partial t} = {K}_{R} 2 \frac{\partial {U}_{Z}}{\partial y} . \qquad ( Eq . 2 )$$

The crossline rotational data R_{Y} (around the crossline axis Y), as measured by a rotational sensor, is proportional to the inline spatial derivative of the vertical translational field (U_{Z}):

$$\frac{\partial {R}_{Y}}{\partial t} = - {K}_{R} 2 \frac{\partial {U}_{Z}}{\partial x} . \qquad ( Eq . 3 )$$

In Eqs. 2 and 3, K_{R} is a calibration operator that depends on the sensor assembly characteristic (assumed to be the same for both rotational components).

It is assumed that the gradient sensors are properly calibrated with respect to the translational survey sensors, such that:

$$\begin{matrix}\frac{\partial {U}_{H}}{\partial t} = ( \frac{\partial {U}_{X}}{\partial x} + \frac{\partial {U}_{Y}}{\partial y} ) , & ( Eq . 4 ) \\ \frac{\partial {R}_{X}}{\partial t} = \frac{\partial {U}_{Z}}{\partial y} , & ( Eq . 5 ) \\ \frac{\partial {R}_{Y}}{\partial t} = \frac{\partial {U}_{Z}}{\partial x} , & ( Eq . 6 )\end{matrix}$$

The above equations (4-6) can be rewritten in the slowness domain (with pₓ=δt/δx and p_{y}=δt/δy):

U_{H}=pₓU_{X}+p_{y}U_{Y}, (Eq. 7)

R_{X}=p_{y}U_{Z}, (Eq. 8)

R_{Y} =pₓU_{Z}, (Eq. 9)

where pₓ and p_{y} are the inline and crossline horizontal slownesses, respectively.
Slowness is the inverse of velocity.

Taking into account the free-surface effect, it can be shown that the incident (parent) upgoing P and S wavefields can be obtained from the translational seismic data with:

$$\begin{matrix}{P}_{up} = - \frac{1 - 2 {β}^{2} {p}^{2}}{2 α {q}_{α}} {U}_{Z} + \frac{{β}^{2}}{α} ( {p}_{x} {U}_{X} + {p}_{y} {U}_{Y} ) , & ( Eq . 10 ) \\ {S}_{up} = p β {U}_{Z} + \frac{1 - 2 {β}^{2} {p}^{2}}{2 β {q}_{β} p} ( {p}_{x} {U}_{X} + {p}_{y} {U}_{Y} ) , & ( Eq . 11 )\end{matrix}$$

where Pᵤₚ and Sᵤₚ are the full incident upgoing P and S wavefields (originating from all directions, i.e. azimuthally independent), α and β flare the near-surface P and S wave velocities, p=(pₓ+p_{y})^{0.5} is the horizontal slowness, q_{α} is the vertical slowness for P waves, and q_{β} is the vertical slowness for S waves. Eqs. 10 and 11 compute the upgoing P and S wavefields based on three translational components: U_{Z}, U_{X}, and U_{Y}. These decomposition equations (10 and 11) can be rewritten as:

$$\begin{matrix}{P}_{up} = - \frac{1 - 2 {β}^{2} {p}^{2}}{2 α {q}_{α}} {U}_{Z} + \frac{{β}^{2}}{α} {U}_{H} , & ( Eq . 12 ) \\ {S}_{up} = p β {U}_{Z} + \frac{1 - 2 {β}^{2} {p}^{2}}{2 β {q}_{β} p} {U}_{H} , & ( Eq . 13 )\end{matrix}$$

Compared to Eqs. 10 and 11, it can be seen that the use of the divergence sensor data (U_{H}) in Eqs. 12 and 13 enables the reduction of the number of input components from three (U_{Z}, U_{X}, and U_{Y}) to two (U_{Z} and U_{H}). From the foregoing, it can be seen that separated P and S wavefields can be derived from translational seismic sensor data (U_{Z}) (measured by a translational survey sensor) and divergence data (U_{H}) (measured by a divergence sensor).

The downgoing P and S wavefields can also be obtained using:

P_{down}=R_{PP}Pᵤₚ, (Eq. 14)

where R_{PP} is the P wave reflection coefficient (from upgoing P to downgoing P) at the free surface. The downgoing P and S wavefield can also be obtained using:

S_{down}=R_{SS}Sᵤₚ, (Eq. 15)

where R_{SS} is the S wave reflection coefficient (from upgoing S to downgoing S) at the free surface.

Generally, according to Eqs. 12-15, the derivation or computation of the separate P wavefield and S wavefield is based on aggregating (e g. summing or taking a difference) of terms based on translational seismic data and gradient sensor data. Even more generally, the translational seismic data and gradient sensor data are combined to derive the separated upgoing and downgoing P and S wavefields.

Under certain conditions, Eqs. 12-15 may suffer from numerical instabilities when p, q_{α}, or q_{β} are equal to zero. They give the correct amplitudes of the total incident wavefields, but in practice it may be desirable to normalize them in order to remove the undesirable wavefield on each individual component, yielding:

$${U}_{Z}^{P} = - \frac{2 α {q}_{α}}{1 - 2 {β}^{2} {p}^{2}} {P}_{up} = {U}_{Z} - \frac{2 {q}_{α} {β}^{2}}{1 - 2 {β}^{2} {p}^{2}} {U}_{H} , \qquad ( Eq . 16 )$$

which is the vertical translational component without any incident-upgoing S wave events (Eq. 14 effectively provides the U_{Z} response due to incident P waves only), and

$${U}_{H}^{S} = \frac{2 {q}_{β} β}{1 - 2 {β}^{2} {p}^{2}} p {S}_{up} = {U}_{H} + \frac{2 {q}_{β} {β}^{2} {p}^{2}}{1 - 2 {β}^{2} {p}^{2}} {U}_{Z} , \qquad ( Eq . 17 )$$

which is the divergence component without any incident-upgoing P wave events (Eq. 15 effectively provides the U_{H} response due to incident S waves only).

In Eqs. 16 and 17 , note that the superscript denotes the type of the parent event, not the type of wave really recorded.

In Eqs. 16 and 17, in contrast to Eqs. 10-15, the free-surface effect is not completely removed. The U_{Z}^{P} and U_{H}^{S} components relate to the incident P and S wavefields respectively, but the backward reflections/conversions at the free interface are not fully compensated for. As an example, U_{H}^{S} results from the S to P conversions at the surface, i.e. U_{H}^{S} is the downgoing P response recorded by the divergence sensor due to incident-upgoing S waves only (the divergence sensor is insensitive to shear energy, but still contains the downward reflected-converted P energy due to incident S waves).

In Eqs. 16-17 for computing the P and S wavefields, respectively, the involved components are azimuthally invariant; therefore the calculated components contain the full incident wavefields (independent of the azimuth). Also, note that Eqs. 12-17 compute the P and S wavefields based on divergence data.

Alternatively, directional horizontal sensor data (U_{X}, U_{Y}, R_{X} and R_{Y}) can be used, where U_{X} represents translational seismic data in the X direction, U_{Y} represents translational seismic data in the Y direction, R_{X} represents the rotation data with respect to the X direction, and R_{Y} represents the rotation data with respect to the Y direction. The translational seismic data U_{X} and U_{Y} are measured by sensing elements of a translational survey sensor, while the rotation data R_{X} and R_{Y} are measured by sensing elements of a rotational sensor. The following sets forth computation of the P and S wavefields using the foregoing directional horizontal sensor data that includes rotational data with respect to the X and Y directions:

$${U}_{X}^{S} = \frac{2 {q}_{β} β}{1 - 2 {β}^{2} {p}^{2}} ( \frac{{p}_{x}}{p} ) {S}_{up}^{( eq . 11 )} = {U}_{X} + \frac{2 {q}_{β} {β}^{2}}{1 - 2 {β}^{2} {p}^{2}} {R}_{Y} , \qquad ( Eq . 18 )$$

which is the horizontal inline translational component without any incident P wave events (i.e. the U_{X} response due to incident S waves only) and

$${U}_{Y}^{S} = \frac{2 {q}_{β} β}{1 - 2 {β}^{2} {p}^{2}} ( \frac{{p}_{y}}{p} ) {S}_{up}^{( eq . 11 )} = {U}_{Y} + \frac{2 {q}_{β} {β}^{2}}{1 - 2 {β}^{2} {p}^{2}} {R}_{X} , \qquad ( Eq . 19 )$$

which is the horizontal crossline translational component without any incident P wave events (i.e. the U_{Y} response due to incident S waves only).

The U_{X} response due to incident P waves only is then given by:

$${U}_{X}^{P} = {U}_{X} - {U}_{X}^{S} = - \frac{2 {q}_{β} {β}^{2}}{1 - 2 {β}^{2} {p}^{2}} {R}_{Y} , \qquad ( Eq . 20 )$$

The U_{Y} response due to incident P waves only is then given by:

$${U}_{Y}^{P} = {U}_{Y} - {U}_{Y}^{S} = - \frac{2 {q}_{β} {β}^{2}}{1 - 2 {β}^{2} {p}^{2}} {R}_{X} , \qquad ( Eq . 21 )$$

Compared to conventional decomposition schemes involving only translational sensor components, a benefit of techniques according to some embodiments is that fewer components (e.g. two components instead of three components) have to be used, which results in greater computation efficiency.

In some implementations, computations to derive the separated P and S wavefields can be performed in a second domain that is different from a time-offset domain in which seismic data and gradient sensor data was acquired. Data in the time-offset domain refers to data at different time points and at different offsets between source and sensor.

The second domain is a domain in which wavefield slownesses can be distinctly computed. Slowness can vary with time and can vary with the type of event (type of wavefield). In some implementations, the second domain can be the tau-p domain (where tau is intercept time and p is horizontal slowness) or the f-k domain (where f is frequency and k is the horizontal wavenumber).

An example of a workflow in the tau-p domain is shown in FIG. 5. A similar workflow can be provided for the f-k domain in other implementations. The workflow of FIG. 5 can also be performed by the processing software 120 of FIG. 1, for example. The workflow first applies (at 502) a tau-p transform on received data, including translational seismic data and gradient sensor data (divergence data and/or rotation data), which are originally in the time-offset domain (data at different time points and at different offsets between source and sensor). Applying a tau-p transform on the received data involves mapping the received data from the time-offset domain to the tau-p transform.

Next, the decomposition equations (according to some of Eqs. 12-21 discussed above) are applied (at 504), to produce separated P and S wavefields. The workflow then applies (at 506) an inverse tau-p transform on the decomposed data (including P and S wavefields), to produce the P and S wavefields in the original time-offset domain. The inverse tau-p transform involves mapping the P and S wavefields in the tau-p transform to the time-offset domain. The P and S wavefields in the time-offset domain are output for further use.

To process an entire dataset (containing received translational seismic data from different seismic sensors), it may be more efficient to process individually common-sensor gathers rather than common-shot gathers. For example, the procedure can be repeated for each common-sensor gather using the known local near-surface properties (at the given sensor location). These near-surface properties can be determined, for example, by P wave travel time inversion, Rayleigh wave velocity inversion, or polarization inversion. Another example approach for determining near-surface properties is described in U.S. Pat. No. 6,903,999.

A potential issue with such decomposition techniques using tau-p or f-k transforms, for example, is that the transforms may show limited performance with real data, especially in the presence of noise and/or static issues. In practice, accurate forward and inverse transformation of land seismic data is often difficult, especially if large amplitude ground-roll noise has not been previously removed from the data. This highlights another potential benefit of using Eqs. 14-17 instead of Eqs. 12 and 13, because only one component has to be forward-inverse transformed, thereby reducing the risk of artifact contamination and reducing the computational time.

Another potential issue is that tau-p or f-k transformations can only be achieved if a relatively large and dense array of spatially unaliased data is available. In addition these approaches implicitly assume a lateral homogeneous subterranean medium over a relatively large extent. With a relatively complex three-dimensionally varying subterranean medium for instance, and in the presence of strong scattering, these approaches may become inefficient.

However, by considering only relatively small slownesses and low near-surface shear wave velocity (e.g. p<α⁻¹<0.6 s/km and β<0.6 km/s, which are reasonable assumptions in most surveys), the following approximations (using Taylor expansion) can be made:

$${U}_{Z}^{P} \approx {U}_{Z} - 2 \frac{{β}^{2}}{α} {U}_{H} + \frac{{β}^{2} ( {α}^{2} - 4 {β}^{2} )}{α} {p}^{2} {U}_{H} , \qquad ( Eq . 22 )$$

U_{H}^{S}≈U_{H}+2βp²U_{Z}, (Eq. 23)

U_{X}^{S}≈U_{X}+2βT_{Y}+3β³p²R_{Y}, (Eq. 24)

U_{Y}^{S}≈U_{Y}+2βR_{X}+3β³p²R_{X}. (Eq. 25)

The first order approximations therefore give:

$${U}_{Z}^{P} \approx {U}_{Z} - 2 \frac{{β}^{2}}{α} {U}_{H} , \qquad ( Eq . 26 )$$

U_{H}^{S}≈U_{H}, (Eq. 27 )

U_{X}^{S}≈U_{X}2βR_{Y}, (Eq. 28)

U_{Y}^{S}≈U_{Y}2βR_{X}. (Eq. 29)

The use of these Eqs. 26-29 can simplify the decomposition procedure as the decomposed P and S wavefields can be obtained directly by weighted summation of the conventional time-offset data (the knowledge of p is no longer required). This is very promising because all the potential issues due to the tau-p or f-k transforms are avoided. Note that Eq. 27 shows that the divergence component contains predominantly the energy due to incident S waves (i.e. the conversion from upgoing S to downgoing P at the free surface).

Such decomposition process (Eqs. 26-29) can be applied locally, it does not require any array of sensors and does not assume a homogeneous subterranean surface. Note that the second order term may also be estimated by spatially differentiating several closely located gradient sensors (this is referred as spatial hopping), even if the second order term contribution (containing p²β or p²β³) should remain very small in most of realistic cases.

By being able to separate P and S wavefields in accordance with some embodiments, more accurate processing of seismic data can be performed for various purposes, such as to characterize a subterranean structure by producing a representation (e.g. image) of the subterranean structure. Various types of analyses can be performed using such image of the subterranean structure.

The processes described in FIGS. 4 and 5 can be implemented with machine-readable instructions (such as the processing software 120 in FIG. 1). The machine-readable instructions are loaded for execution on a processor or multiple processors(e.g. 122 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving seismic data relating to a subterranean structure from at least one translational survey sensor;
receiving gradient sensor data from at least one gradient sensor; and
separating a P wavefield and an S wavefield in the seismic data, based on the seismic data and the gradient sensor data.

2. The method of claim 1, wherein the gradient sensor data is received from a rotational sensor.

3. The method of claim 1, wherein the gradient sensor data is received from a divergence sensor.

4. The method of claim 3, wherein the gradient sensor data is received from the divergence sensor that has a pressure sensor and a container filled with a material, where the pressure sensor is immersed in the material.

5. The method of claim 1, wherein the gradient sensor data is received from a rotational sensor and a divergence sensor.

6. The method of claim 1, wherein the gradient sensor data is obtained from translational data measured by translational survey sensors spaced apart by less than a predetermined distance.

7. The method of claim 1, wherein separating the P wavefield and the S wavefield comprises identifying an upgoing P wavefield and a downgoing P wavefield.

8. The method of claim 7, wherein separating the P wavefield and the S wavefield further comprises identifying an upgoing S wavefield and a downgoing S wavefield.

9. The method of claim 1, wherein the translational survey sensor and the gradient sensor are collocated.

10. The method of claim 1, wherein receiving the seismic data from the at least one translational survey sensor comprises receiving the seismic data from one of a single-component sensor, a two-component sensor, and a three-component sensor.

11. A system comprising:
a storage medium to store seismic data acquired by at least one translational survey sensor, and gradient sensor data acquired by at least one gradient sensor; and
at least one processor to:
combine the seismic data and the gradient sensor data to derive a P wavefield and an S wavefield.

12. The system of claim 11, wherein the at least one processor is to combine the seismic data and the gradient sensor data to derive an upgoing P wavefield, a downgoing P wavefield, an upgoing S wavefield, and a downgoing S wavefield.

13. The system of claim 11, further comprising the at least one translation survey sensor and the at least one gradient sensor, wherein the at least one gradient sensor is selected from among a divergence sensor, a rotational sensor, and a combination of a divergence sensor and a rotational sensor.

14. The system of claim 13, wherein the translation survey sensor is selected from among a geophone, an accelerometer, and a microelectromechanical systems sensor.

15. The system of claim 11, wherein the translation survey sensor and the gradient sensor are collocated.

16. The system of claim 11, wherein the at least one processor is to further:
transform the seismic data and the gradient sensor data from a time-offset domain to a second domain that allows wavefield slownesses to be distinctly computed, wherein the combining is performed in the second domain; and
inverse transform the P wavefield and S wavefield from the second domain to the time-offset domain.

17. The system of claim 16, wherein the second domain is one of a tau-p domain and a f-k domain.

18. The system of claim 16, wherein the at least one translational survey sensor is a single translational survey sensor, and the at least one gradient sensor is a single gradient sensor, and the at least one processor is to combine the seismic data of the single translational survey sensor and the single gradient sensor.

19. An article comprising at least one machine-readable storage medium storing instructions that upon execution cause a system to:
receive seismic data relating to a subterranean structure from at least one translational survey sensor;
receive gradient sensor data from at least one gradient sensor; and
separate a P wavefield and an S wavefield in the seismic data, based on combining the seismic data and the gradient sensor data.

20. The article of claim 19, wherein the gradient sensor data is received from a divergence sensor, a rotational sensor, or a combination of a divergence sensor and rotational sensor.

21. The article of claim 19, wherein the separating causes separation of an upgoing P wavefield, a downgoing P wavefield, an upgoing S wavefield, and a downgoing S wavefield.
